(19) United States
(12) Patent Application Publication
(10) Pub. No.: US 2012/0172162 A1
(43) Pub. Date: Jul. 5, 2012

(54) CVT of radio-controlled car

(76) Inventor: Shu-Mei Tseng, New Taipei City (TW)

(21) Appl. No.: 12/982,887

(22) Filed: Dec. 31, 2010

(51) Int. Cl. F16H 61/662; F16H 55/56

(52) U.S. Cl. 474/15

(57) ABSTRACT

A CVT of radio-controlled car includes a drive assembly operatively connected to an electric motor and comprising a fixed disc and a co-axial moveable disc; an idler assembly operatively connected to the main shaft and comprising a fixed inner disc and a co-axial moveable outer disc; a belt rotatably mounted around the drive assembly and the idler assembly; a convex disc mounted besides the drive assembly distal the fixed disc; a main spring biased between the convex disc and the moveable disc wherein an internal space defined by the convex disc and the moveable disc is substantially closed; a rotatable steel ball engaged with the main spring; a receptacle disposed externally of the idler assembly; and a spring member biased between the receptacle and a central portion of the outer disc.

### BACKGROUND OF THE INVENTION

1. Field of Invention

The invention relates to transmission of radio-controlled car and more particularly to a continuously variable transmission (CVT) of a radio-controlled car.

2. Description of Related Art

A typical transmission of a radio-controlled car 1 is shown in FIG. 1. A battery powered electric motor 10 has an output shaft rotatably connected to a center of a gear assembly 11. A belt 12 is provided to transmit the output (i.e., torque) of the gear assembly 11 to a main shaft 13 which in turn drives, for example, front wheels.

For increasing or decreasing the speed of the car 1, the gear ratios of the gear assembly 11 are required to switch between them. This, however, can lower performance due to mesh engagement of the gears. Thus, the need for improvement still exists.

### SUMMARY OF THE INVENTION

It is therefore one object of the invention to provide a transmission of a radio-controlled car including a battery powered electric motor and a main shaft, comprising a drive assembly operatively connected to the electric motor and comprising a fixed disc and a co-axial moveable disc spaced from the fixed disc wherein a distance between centers of the fixed disc and the moveable disc is less than a distance between peripheries of the fixed disc and the moveable disc; an idler assembly operatively connected to the main shaft and comprising a fixed inner disc and a co-axial moveable outer disc proximate to the inner disc wherein a distance between centers of the inner disc and the outer disc is less than a distance between peripheries of the inner disc and the outer disc; a belt rotatably mounted around the drive assembly and the idler assembly; a co-axial convex disc mounted besides the drive assembly distal the fixed disc; a main spring biased between the convex disc and the moveable disc wherein an internal space defined by the convex disc and the moveable disc is substantially closed; a rotatable steel ball engaged with the main spring; a receptacle disposed externally of the idler assembly; and a spring member biased between the receptacle and a central portion of the outer disc; wherein a portion of the belt in the drive assembly is proximate to s center of the drive assembly and a portion of the belt in the idler assembly is proximate to a periphery of the idler assembly; and wherein output torque of the electric motor is increased as speed of the electric motor increases and in response the portion of the belt in the drive assembly moves toward a periphery of the drive assembly, the portion of the belt in the idler assembly moves toward a center of the idler assembly, the steel ball moves toward a periphery of the moveable disc, the main spring expands to disengage the convex disc from the moveable disc, the moveable disc moves toward the fixed disc, and the inner disc and the outer disc are further disengaged to compress the spring member.

The above and other objects, features and advantages of the invention will become apparent from the following detailed description taken with the accompanying drawings.

### BRIEF DESCRIPTION OF THE DRAWINGS

FIG. 1 schematically depicts typical transmission of a radio-controlled car;

FIG. 2 schematically depicts a transmission of a radio-controlled car according to the invention;

FIG. 3 is a side elevation of the belt, the drive assembly, and the idler assembly of FIG. 2 showing different positions of the belt as speed increases; and

FIG. 4 is a front view of the belt, the drive assembly, the idler assembly, and associated components of FIG. 2 corresponding to FIG. 3.

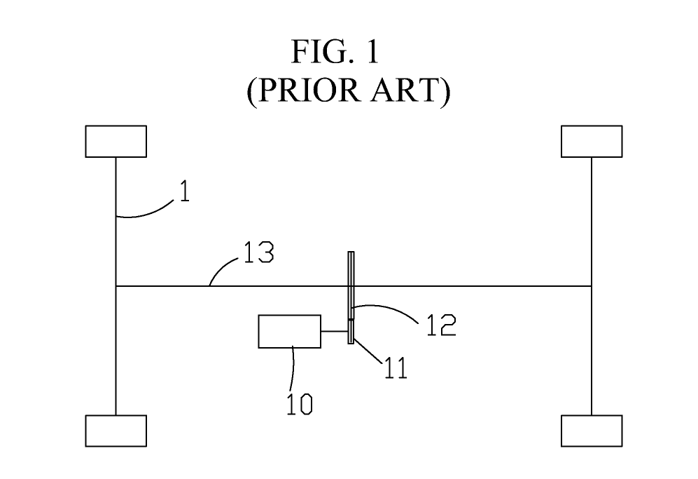

### DETAILED DESCRIPTION OF THE INVENTION

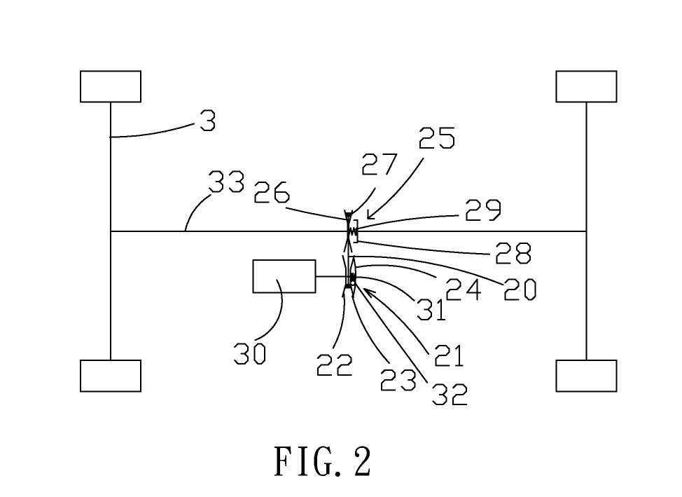

Referring to FIGS. 2 to 4, a transmission of a radio-controlled car 3 in accordance with the invention comprises the following components as discussed in detail below.

A battery powered electric motor 30 has an output shaft rotatably connected to a drive assembly 21 comprising a fixed disc 22 and a co-axial moveable disc 23 spaced from the fixed disc 22 by a distance. The distance between centers of the fixed disc 22 and the moveable disc 23 is less than the distance between the peripheries of the fixed disc 22 and the moveable disc 23. That is, a substantially X is seen from top of both the fixed disc 22 and the moveable disc 23.

A main shaft 33 has an idler assembly 25 mounted thereon. The idler assembly 25 comprises a fixed inner disc 26 and a co-axial moveable outer disc 27 proximate to the inner disc 26. The distance between centers of the inner disc 26 and the outer disc 27 is less than the distance between the peripheries of the inner disc 26 and the outer disc 27. That is, a substantially X is seen from top of both the inner disc 26 and the outer disc 27.

A belt 20 is rotatably mounted around the drive assembly 21 and the idler assembly 25. A co-axial convex disc 24 is mounted on the other side of the drive assembly 21 opposite the fixed disc 22. A main spring 32 is biased between the convex disc 24 and the moveable disc 23. Internal space, with the main spring 32 disposed therein, defined by the convex disc 24 and the moveable disc 23 is substantially closed. A steel ball 32 is provided besides the main spring 32. A receptacle 28 is provided externally of the idler assembly 25 and co-axial therewith. A spring member 29 is biased between the receptacle 28 and the center of the outer disc 27.

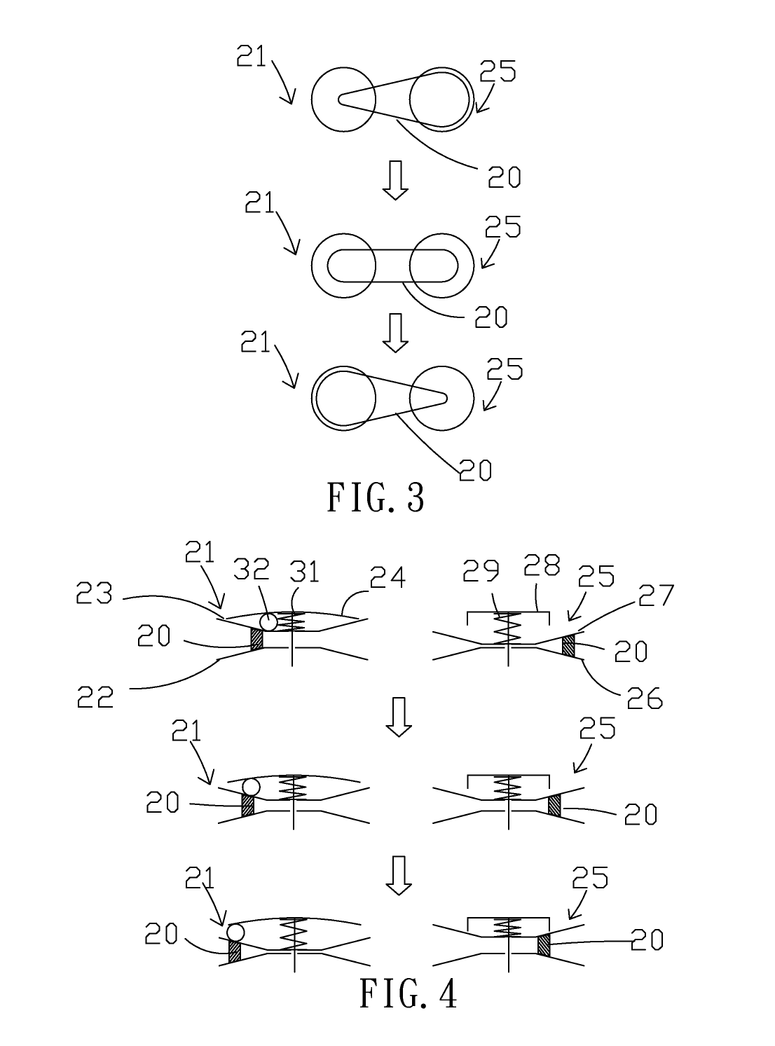

As shown in the tops of both FIGS. 3 and 4, speed is low when the electric motor 30 starts. The portion of the belt 20 in the drive assembly 21 is proximate to center of the drive assembly 21 and the portion of the belt 20 in the idler assembly 25 is proximate to the periphery of the idler assembly 25. Also, the steel ball 32 is engaged with the main spring 31, and the moveable disc 23 is spaced from the fixed disc 22.

As shown in the middles of both FIGS. 3 and 4, output torque is gradually increased as speed of the electric motor 30 increases. The portion of the belt 20 in the drive assembly 21 is at an intermediate point between the center of the drive assembly 21 and the periphery thereof and the portion of the belt 20 in the idler assembly 25 is at an intermediate point between the periphery of the idler assembly 25 and the center thereof. Also, the steel ball 32 is disengaged from the main spring 31 to slide to an intermediate point between the main spring 31 and the periphery of the moveable disc 23. Further, the convex disc 24 and the moveable disc 23 are disengaged due to the expansion of the main spring 31, the moveable disc 23 moves toward the fixed disc 22, and the inner disc 26 and the outer disc 27 are disengaged with the spring member 29 being compressed. All of the above effects are a result of increased centrifugal force in response to speed increase.

As shown in the bottoms of both FIGS. 3 and 4, output torque is increased to a maximum as speed of the electric motor 30 increases to a maximum. The portion of the belt 20 in the drive assembly 21 is at the periphery of the drive assembly 21 and the portion of the belt 20 in the idler assembly 25 is at the center of the idler assembly 25. Also, the steel ball 32 is further disengaged from the main spring 31 to slide to the periphery of the moveable disc 23. The convex disc 24 and the moveable disc 23 are further disengaged due to the further expansion of the main spring 31, the moveable disc 23 moves to be proximate to the fixed disc 22, and the inner disc 26 and the outer disc 27 are further disengaged with the spring member 29 being further compressed. All of the above effects are also a result of increased centrifugal force in response to speed increase.

In brief, the output torque of the main shaft 33 is governed by the idler assembly 25 which is in turn controlled by the belt 20 and other components described above. Therefore, a continuously variable transmission (CVT) of the radio-controlled car is effected.

While the invention has been described in terms of preferred embodiments, those skilled in the art will recognize that the invention can be practiced with modifications within the spirit and scope of the appended claims.

What is claimed is:

1. A transmission of a radio-controlled car including a battery powered electric motor and a main shaft, comprising:
a drive assembly operatively connected to the electric motor and comprising a fixed disc and a co-axial moveable disc spaced from the fixed disc wherein a distance between centers of the fixed disc and the moveable disc is less than a distance between peripheries of the fixed disc and the moveable disc;
an idler assembly operatively connected to the main shaft and comprising a fixed inner disc and a co-axial moveable outer disc proximate to the inner disc wherein a distance between centers of the inner disc and the outer disc is less than a distance between peripheries of the inner disc and the outer disc;
a belt rotatably mounted around the drive assembly and the idler assembly;
a co-axial convex disc mounted besides the drive assembly distal the fixed disc;
a main spring biased between the convex disc and the moveable disc wherein an internal space defined by the convex disc and the moveable disc is substantially closed;
a rotatable steel ball engaged with the main spring;
a receptacle disposed externally of the idler assembly; and
a spring member biased between the receptacle and a central portion of the outer disc;
wherein a portion of the belt in the drive assembly is proximate to s center of the drive assembly and a portion of the belt in the idler assembly is proximate to a periphery of the idler assembly; and
wherein output torque of the electric motor is increased as speed of the electric motor increases and in response the portion of the belt in the drive assembly moves toward a periphery of the drive assembly, the portion of the belt in the idler assembly moves toward a center of the idler assembly, the steel ball moves toward a periphery of the moveable disc, the main spring expands to disengage the convex disc from the moveable disc, the moveable disc moves toward the fixed disc, and the inner disc and the outer disc are further disengaged to compress the spring member.
